(19) United States
(12) Patent Application Publication
(10) Pub. No.: US 2016/0190546 A1
(43) Pub. Date: Jun. 30, 2016

(54) POSITIVE ELECTRODE COMPOSITE MOUNTED IN ALL-SOLID BATTERY

(71) Applicant: Hyundai Motor Company, Seoul (KR)

(72) Inventors: Yong Sub Yoon, Seoul (KR); Byung Jo Jeong, Seoul (KR); Sang Heon Lee, Yongin (KR); Kyung Su Kim, Yongin (KR); Hong Seok Min, Yongin (KR)

(21) Appl. No.: 14/729,543

(22) Filed: Jun. 3, 2015

(30) Foreign Application Priority Data
Dec. 24, 2014 (KR) 10-2014-0188628

(51) Int. Cl. H01M 4/13; H01M 4/04; H01M 10/056; H01M 4/66; H01M 4/62; H01M 4/139

(52) U.S. Cl. CPC H01M 4/13; H01M 4/621; H01M 4/139; H01M 10/056; H01M 4/661; H01M 4/043; H01M 4/0471; H01M 2004/028

(57) ABSTRACT

Disclosed is a positive electrode composite in an all-solid battery. In particular, contents of the electrolyte, the positive electrode material, and the conductive material are non-linearly changed from the electrolyte layer toward the metal current collector. Accordingly, as being closer to the electrolyte layer, ion conductivity is increased, and as being closer to the metal current collector, electron conductivity is increased, such that the electrochemical reactions may be actively performed in the entire internal portion of the positive electrode composite.

### CROSS-REFERENCE TO RELATED APPLICATION

This application is based on and claims the benefit of priority to Korean Patent Application No. 10-2014-0188628, filed on Dec. 24, 2014 in the Korean Intellectual Property Office, the disclosure of which is incorporated herein in its entirety by reference.

### TECHNICAL FIELD

The present invention relates to a positive electrode composite disposed in an all-solid battery. In particular, the positive electrode composite may efficiently induce electrochemical reactions by having concentration gradients of components contained therein.

### BACKGROUND

A conventional lithium secondary battery according to the related art includes an electrolyte containing a combustible organic solvent, such that when external impact is applied and a cell is not controlled, serious safety problems may be generated.

Therefore, an additional structure for separately improving safety may be required to be applied in addition to a basic structure of a battery cell, or an additional safety device may be required to be mounted in the lithium secondary battery according to the related art.

An all-solid battery has been modified from the lithium secondary battery according to the related art, and thus the all-solid battery may include the electrolyte which is particularly replaced by a solid electrolyte. Since, in the all-solid battery as described above, the safety problem of the lithium secondary battery according to the related art may be reduced, the all-solid battery has been spotlighted as a new generation battery.

However, as a liquid-phase electrolyte is replaced by a solid-phase electrolyte, at the time of electrochemical reactions in an electrode structure, resistance may be increased, such that energy density and power performance thereof may be reduced as being compared to the lithium secondary battery according to the related art.

For example, as an electrolyte, a positive electrode material, a conductor material, and a binder are coated on a metal current collector as a thick film form, a positive electrode composite of a current all-solid battery may be bonded to a solid-phase electrolyte layer to thereby be manufactured as a battery cell.

A battery generates electric energy by electrochemical reactions in the electrode. Particularly for the all-solid battery, electrons may move along a path from the metal current collector through the conductive material to the positive electrode material. Further, lithium ions may move along a path from a negative electrode that is adhered to the electrolyte layer, as being symmetric to the positive electrode composite, through the electrolyte layer and the electrolyte included in the positive electrode composite, to the positive electrode material. Accordingly, the lithium ions in the positive electrode material may be stored and discharged.

However, as compared to the lithium secondary battery according to the related art which contains the liquid-phase electrolyte in which ions relatively freely move, in the all-solid battery, ion conductivity as well as electron conductivity should be considered. Further, in the all-solid battery, internal resistance may be increased as compared to the lithium secondary battery according to the related art. In order to solve such problems, there is a need to develop a new material and improve a structure of the all-solid battery.

### SUMMARY

In preferred aspects, the present invention has been made to solve the above-discussed problems occurring in the related art while advantages achieved by the related art are maintained intact.

In one aspect, the present invention provides a positive electrode composite that is disposed in an all-solid battery and capable of minimizing internal resistance of the positive electrode composite, such that electrochemical reactions may be efficiently induced by adjusting a material content concentration along conduction paths of ions and electrons of the positive electrode composite in the all-solid battery.

According to an exemplary embodiment of the present invention, the positive electrode composite disposed in an all-solid battery may be interposed between an electrolyte layer and a metal current collector, for example, the electrolyte layer and the metal current collector as being symmetric to each other. In particular, contents of an electrolyte, a positive electrode material, and a conductive material contained in the positive electrode composite may be non-linearly changed from a region coming in contact with the electrolyte layer to a region coming in contact with the metal current collector.

As used herein, “non-linearly changed” means that a change may not be related to or proportional to a variable or an element. For example, the contents of the components in the positive electrode composite may not be related to or proportional to a height range from a bottom surface such as the current collector.

Further, as used herein, “symmetric” means that objects are disposed facing to each other wherein a plane or a line is positioned therebetween. For example, an electrolyte layer and a metal current collector of an all-solid battery may be positioned at least substantially facing to each other, and a plane including a positive electrode composite (layer) may divide the space between the electrolyte layer and the metal current collector. It is understood that objects in a symmetric orientation as referred to herein may not be, e.g., in a precisely parallel orientation, but can be offset by varying amount, such as up to about 5, about 10, about 15, about 20 or about 25 degrees or more offset.

In another aspect, the present invention provides an all-solid battery that comprises the positive electrode composite as described above.

Further provided is a method of preparing the positive electrode composite as described herein. For example, each mixture of the electrolyte, the positive electrode material, and the conductive material may be prepared at a predetermined content ratio and the predetermined content ratio may be non-linearly changed in each mixture. Subsequently, a plurality of the thus prepared mixtures having different predetermined content ratios may be stacked so as to form layers and the stacked mixture layers may be stacked or compressed. In particular, the positive electrode material, and the conductive material may be in powder form, and further, a binder may be mixed with the electrolyte, the positive electrode material, and the conductive material.

Other aspects of the invention are disclosed infra.

### BRIEF DESCRIPTION OF THE DRAWINGS

The above and other objects, features and advantages of the present invention will be more apparent from the following detailed description taken in conjunction with the accompanying drawings.

FIG. 1 is an exemplary positive electrode composite disposed in an all-solid battery according to an exemplary embodiment of the present invention.

FIG. 2 is a graph illustrating an exemplary content ratio change of an exemplary positive electrode composite disposed in the all-solid battery of FIG. 1.

FIG. 3 is an exemplary electrochemical reaction area of a conventional positive electrode composite in the related art.

### DETAILED DESCRIPTION

The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter reference will now be made in detail to various exemplary embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

An exemplary embodiment of the present invention will be described in detail with reference to the accompanying drawings.

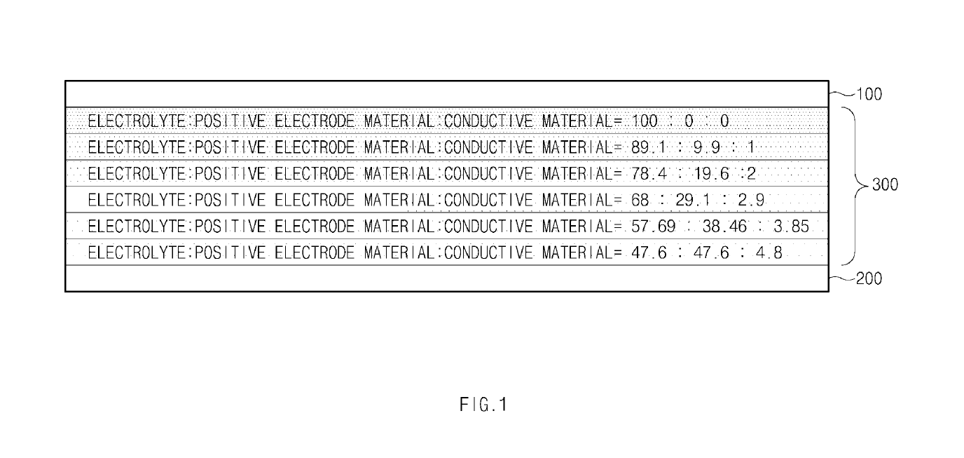

As illustrated in FIGS. 1 to 3, a positive electrode composite 300 may be disposed in an all-solid battery. The positive electrode composite 300 may be interposed between an electrolyte layer 100 and a metal current collector 200 such that, for example, the electrolyte layer 100 and the metal current collector 200 may be symmetric to each other. Further, as shown in FIG. 1, contents of an electrolyte, a positive electrode material, and a conductive material contained in the positive electrode composite 300 may be non-linearly changed from a region coming in contact with the electrolyte layer 100 to a region coming in contact with the metal current collector 200. In particular, the contents of the positive electrode material and the conductive material may be changed in an inverse proportion to the content change of the electrolyte.

The positive electrode composite according to an exemplary embodiment of the present invention may be formed by preparing a mixture of the electrolyte, the positive electrode material, and the conductive material prepared in a powder form at predetermined content ratio, stacking a plurality of the mixtures having different content ratios so as to form layers, and then heating or compressing the stacked mixture layers. In particular, a binder may be mixed with other materials in the powder form to thereby firmly adhere the positive electrode composite.

The content of the electrolyte may be decreased from the electrolyte layer 100 toward the metal current collector 200. As such, lithium ions may smoothly move. The content of the positive electrode material may be increased from the electrolyte layer 100 toward the metal current collector 200, and accordingly, a possibility of a short-circuit with a negative electrode through the electrolyte layer 100 may be minimized. Further, the content of the conductive material may be increased from the electrolyte layer 100 toward the metal current collector 200, and electrons may more smoothly move.

In addition, the content of the electrolyte may be changed such that the content of the electrolyte at the region coming in contact with the metal current collector 200 may vary from about 0 to about 0.8 times of the content of the electrolyte at the region coming in contact with the electrolyte layer 100. The positive electrode composite may be prepared such that the contents of the conductive material and the positive electrode material at the region coming in contact with the electrolyte layer 100 may be from about 0 to about 0.3 times of the content of the electrolyte at the region coming in contact with the electrolyte layer 100, such that the contents of the conductive material and the positive electrode material may be changed in an inverse proportion to the content change of the electrolyte.

In the exemplary embodiment of the present invention, the positive electrode composite may be prepared such that the content of the electrolyte at the region coming in the metal current collector 200 may be about 0.5 times of the content of the electrolyte at the region coming in contact with the electrolyte layer 100. In addition, the positive electrode composite may be prepared such that the contents of the conductive material and the positive electrode material at the region coming in contact with the electrolyte layer 100 may be about 0 time of the content of the electrolyte at the region coming in contact with the electrolyte layer 100.

Particularly, at the region coming in contact with the electrolyte layer 100, the electrolyte and the positive electrode material may be mixed at a content ratio of about 100:0 to about 80:20 and the conductive material may be contained at a content of about 0 to 1 wt %, based on the total weight of the positive electrode composite. Further, at the region coming in contact with the metal current collector 200, the electrolyte and the positive electrode material may be mixed at a content ratio of about 0:100 to about 50:50 and the conductive material may be contained at a content of about 1 to 10 wt %, based on the total weight of the positive electrode composite.

According to the exemplary embodiment of the present invention, the positive electrode composite may be prepared such that a content ratio of the electrolyte, the positive electrode material, and the conductive material may be about 100:0:0 at the region coming in contact with the electrolyte layer 100 and the content ratio may be about 47.6:47.6:4.8 at the region coming in contact with the metal current collector 200 as illustrated in FIG. 1.

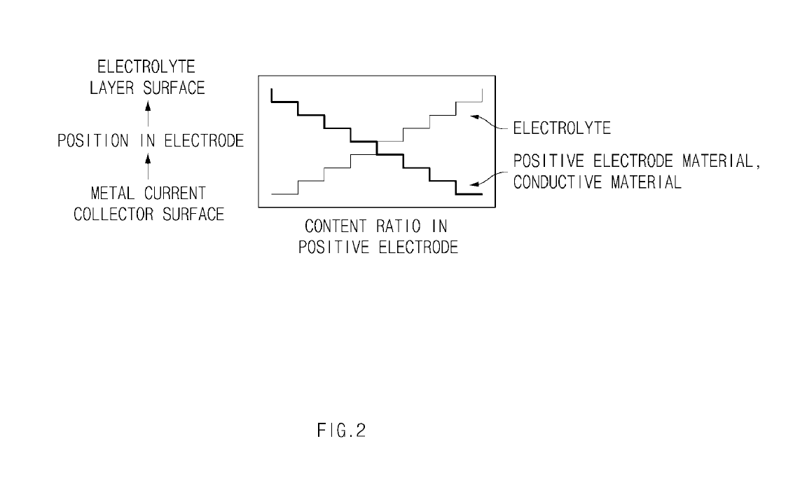

The content ratio at a region between the electrolyte layer 100 and the metal current collector 200 may be non-linearly changed. That is, the positive electrode composite may be prepared so as to have the same content ratio in a predetermined height range when the metal current collector 200 may be considered as a bottom surface as shown in FIG. 2.

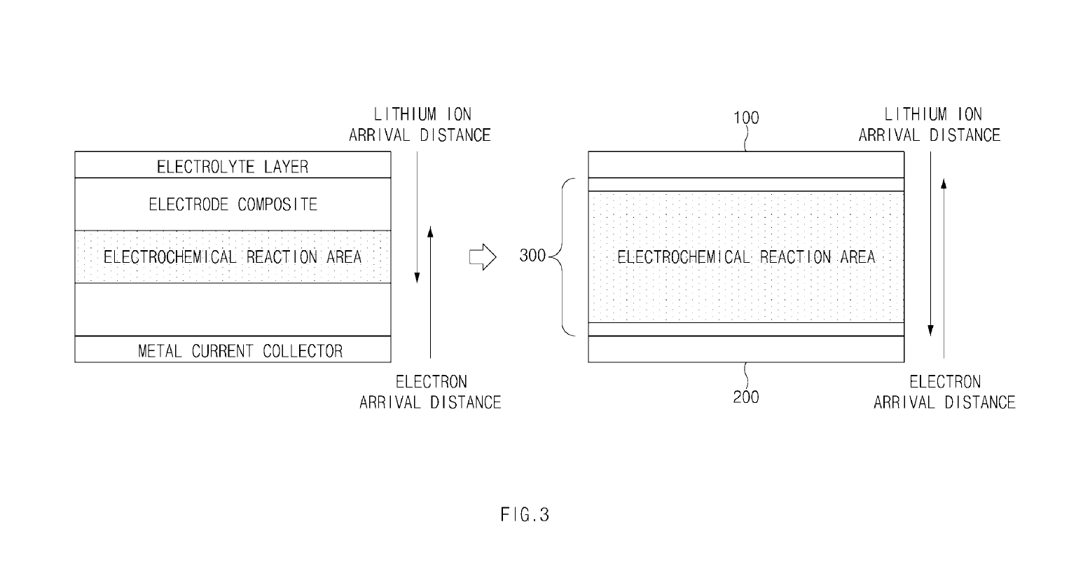

As illustrated in FIG. 3, a conventional positive electrode composite 300 according to the related art may be prepared by coating an electrolyte, a positive electrode material, and a conductive material, such that electrochemical reactions are carried out only at an interface between the electrolyte and the positive electrode material. However, according to the present invention, the positive electrode composite may be prepared such that the electrolyte, the positive electrode material, and the conductive material may have specific content ratios at the predetermined height range when the metal current collector 200 is considered as the bottom surface. Accordingly, generation of a short-circuit with the negative electrode through the electrolyte layer 100 may be minimized, mobility of the lithium ion and the electrons may be increased, internal resistance may be minimized, and an electrochemical reaction area may be maximized.

Further, in the conventional positive electrode composite of the all-solid battery, when the electrolyte, the positive electrode material, and the conductive material are coated in a thick film form, the electrochemical reactions were concentrated on the surface of the electrolyte. However, when the positive electrode composite is disposed in an all-solid battery according to the present invention as described above, as being closer to the electrolyte layer, ion conductivity may be increased, and as being closer to the metal current collector, electron conductivity may be increased. Accordingly, the electrochemical reactions may be actively performed in the entire internal portion of the positive electrode composite.

In the related art, there has been a limitation in a thickness of the positive electrode composite due to internal resistance, but when the positive electrode composite of the present invention is applied, internal resistance may be decreased, such that a weight of the positive electrode composite disposed in the all-solid battery may be increased.

Further, the internal resistance may be decreased, such that energy density, or alternatively, an energy content capable of being charged and discharged in the all-solid battery may be increased.

In addition, the energy density may be increased, such that the all-solid battery may be designed so as to have a more compact appearance as compared to a conventional all-solid battery according to the related art.

Further, since an active material, or particularly, the positive electrode material may not exist at an interface or at a contact region between the electrolyte layer and the positive electrode composite, occurrence of the short-circuit between positive and negative electrodes through the electrolyte layer may be reduced.

As described above, although the present invention has been described with reference to exemplary embodiments and the accompanying drawings, it would be appreciated by those skilled in the art that the present invention is not limited thereto but various modifications and alterations might be made without departing from the scope defined in the claims to be provided below and their equivalents.

What is claimed is:

1. A positive electrode composite for an all-solid battery, the positive electrode composite being interposed between an electrolyte layer and a metal current collector,
wherein contents of an electrolyte, a positive electrode material, and a conductive material contained in the positive electrode composite are changed from a region in contact with the electrolyte layer to a region in contact with the metal current collector.

2. The positive electrode composite according to claim 1, wherein the electrolyte layer and the metal current collector are symmetric to each other.

3. The positive electrode composite according to claim 1, wherein the content of the electrolyte is decreased from the electrolyte layer toward the metal current collector, and the content of the conductive material is increased from the electrolyte layer toward the metal current collector.

4. The positive electrode composite according to claim 1, wherein the content of the positive electrode material is changed in an inverse proportion to a content change of the electrolyte.

5. The positive electrode composite according to claim 1, wherein the content of the conductive material is changed in an inverse proportion to a content change of the electrolyte.

6. The positive electrode composite according to claim 1, wherein, at the region in contact with the electrolyte layer, the electrolyte and the positive electrode material are mixed at a content ratio of about 100:0 to about 80:20 and the conductive material is contained at a content of about 0 to 1 wt % based on the total weight of the positive electrode composite.

7. The positive electrode composite according to claim 1, wherein, at the region in contact with the metal current collector, the electrolyte and the positive electrode material are mixed at a content ratio of about 0:100 to about 50:50 and the conductive material is contained at a content of about 1 to 10 wt % based on the total weight of the positive electrode composite.

8. An all-solid battery that comprises a positive electrode composite of claim 1.

9. A method of preparing a positive electrode composite of claim 1, comprising:
preparing a mixture of an electrolyte, a positive electrode material, and a conductive material prepared at a predetermined content ratio, wherein the predetermined content ratio is non-linearly changed;
stacking a plurality of the mixtures having different predetermined content ratios so as to form layers; and
heating or compressing the layers.

10. The method of claim 9, wherein the electrolyte, the positive electrode material, and the conductive material are in powder form.

11. The method of claim 9, a binder is mixed with the electrolyte, the positive electrode material, and the conductive material.
